(19) United States
(12) Patent Application Publication
(10) Pub. No.: US 2015/0006204 A1
(43) Pub. Date: Jan. 1, 2015

(54) STORAGE AREA MANAGEMENT METHOD AND SERVER APPARATUS

(71) Applicant: FUJITSU LIMITED, Kawasaki-shi (JP)

(72) Inventors: Naoki MIYOSHI, Machida (JP); Akio SHIMONO, Yokohama (JP)

(21) Appl. No.: 14/488,812

(22) Filed: Sep. 17, 2014

Related U.S. Application Data
(63) Continuation of application No. PCT/JP2012/057013, filed on Mar. 19, 2012.

(51) Int. Cl. G06F 19/00; G06F 21/62

(52) U.S. Cl. CPC G06F 19/322; G06F 21/6245
USPC 705/3

(57) ABSTRACT

A storage area management method executed by a computer, includes generating a first facility user ID, with which a user can be identified, for the user using a first facility in a first data storage area managed by the first facility; identifying a first personal information ID to specify a first personal information storage area storing personal attribute information attributed to the user, by an input from the user on use of the first facility, or identifying a second personal information ID newly specifying a second personal information storage area from a personal information storage unit; and storing data generated by the use of the first facility by the user, in the first data storage area and in a storage area identifiable among one of the first personal information storage area and the second personal information storage area.

### CROSS-REFERENCE TO RELATED APPLICATIONS

This application is a continuation application of International Application PCT/JP2012/057013 filed on Mar. 19, 2012 and designated the U.S., the entire contents of which are incorporated herein by reference.

### FIELD

The disclosures herein generally relate to a storage area management method and a server apparatus to manage a storage area of data relating to the same user.

### BACKGROUND

It has been conventionally practiced that data of a user is shared among multiple facilities. A technology has been proposed to share information about a user between staff offering an elderly care service and the user receiving the elderly care service by having multiple facilities use the same system. It is a technology for the staff working at multiple offices to share elderly care service information required for offering the elderly care service to the user.

At each of the offices, a user information ID is provided to uniquely identify the staff and the user. Also, a user ID is provided to uniquely identify the staff and the user commonly among the multiple offices. When a new user is registered at an office, a user ID is searched for based on information input for the new user (such as an elderly care insurance number), and if the user ID is found, a newly assigned user information ID is associated with the registered user ID to be recorded. As a result, it is possible to share the information about the user among the multiple offices by using the user ID.

Also, a technology has been proposed to determine an equivalence of duplicated personal information by converting data into a uniform representation.

### RELATED-ART DOCUMENTS

### Patent Documents

[Patent Document 1] Japanese Patent No. 4658225
[Patent Document 2] Japanese Laid-open Patent Publication No. 2005-011049

Considering that the above conventional technologies are used at hospitals as offices, there are cases where the same patient receives examinations at multiple hospitals. Basic data of the patient is useful information for an examination at any hospital. The basic data may include the age, body weight, body height, normal blood pressure, blood type, medical history, and the like. Also, one may consider to use the results data of a test performed at a hospital commonly among multiple hospitals, instead of treating it as private information in a specific hospital. Using the above conventional technologies, the data of the patient may be shared among multiple hospitals.

On the other hand, when a patient goes to a hospital, the patient can arbitrarily decide which hospital the patient will go for receiving an examination. Therefore, if the patient receives an examination at a hospital not using the same system, a problem may arise in that the data of the patient cannot be shared.

Moreover, even if a hospital uses the system, there are cases where the patient cannot disclose information used to identify the patient in the system to the hospital in person when the patient loses the patient registration card, or when the patient is a stray dog protected by a person different from the owner at an animal hospital, and the person brings the stray dog (patient) to have treatment. In such cases, when receiving treatment at a hospital, even if treatment information exists that has been recorded at another hospital in the past, the hospital cannot confirm the existence of the treatment information, and cannot refer to it.

Also, as another aspect, there has been a problem in that data inherently attributed to a user is shared by a person other than the user or an organization, regardless of an intension of the user because sufficient care is not taken to distinguish information generated when the patient has received an examination at a hospital, as data attributed to the hospital, or as data attributed to the user.

Further, as yet another aspect, using the conventional technologies, in a search process to determine an equivalence of information, information about a user in question is searched for and accessed regardless of an intension of the user, to make an equivalence determination of the information. Namely, an equivalence determination is output as a search result. In other words, data exists as information relating to a user that can be searched for, but in some cases, this fact itself may need to be treated as confidential. Thus, the problem is that a user's personal information may be accessed in a circumstance where the user does not know anything about it.

### SUMMARY

According to at least an embodiment of the present invention, a storage area management method executed by a computer includes generating a first facility user ID for a user intending to use a first facility in a first data storage area under management of the first facility, the first facility user ID being capable of identifying the user under the management of the first facility; identifying a first personal information ID to specify a first personal information storage area storing personal attribute information attributed to the user, by an input from the user on use of the first facility, or identifying a second personal information ID newly specifying a second personal information storage area from a personal information storage unit; and storing data generated by the use of the first facility by the user, in the first data storage area and in a storage area identifiable among one of the first personal information storage area and the second personal information storage area.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a diagram illustrating a conceptual configuration of a system according to an embodiment of the present invention;

FIG. 2 is a diagram illustrating a merge process by a merge application;

FIG. 3 is a diagram illustrating a hardware configuration of a server apparatus;

FIG. 4 is a diagram illustrating a functional configuration of the server apparatus;

FIG. 5 is a diagram illustrating an example of a data configuration in a data storage base;

FIG. 6A is a flowchart illustrating a new patient reception process at a facility A, and FIG. 6B is a flowchart illustrating a new patient reception process at a facility B;

FIG. 7A is a flowchart illustrating an examination data read process before merging at the facility A, and FIG. 7B is a flowchart illustrating an examination data store process before merging at the facility A;

FIG. 8 is a flowchart illustrating an examination data read process after merging at the facility A;

FIG. 9A is a flowchart illustrating an examination data read process after merging at the facility B, and FIG. 9B is a flowchart illustrating an examination data store process after merging at the facility B;

FIG. 10 is a flowchart illustrating a merge process; and

FIG. 11 is a diagram illustrating an example of a screen for setting merge information.

### DESCRIPTION OF EMBODIMENTS

In the following, embodiments of the present invention will be described with reference to the drawings. In the present embodiment, information generated by use of a facility such as a hospital can be managed by separating it into personal attribute information attributed to an individual user, and facility attribute information attributed to the facility. Also, if a user explicitly expresses an initiative, personal attribute information obtained at respective facilities can be merged to be shared among the facilities, without changing information used to identify the user in individual systems in the respective facilities, and information to refer to the personal attribute information.

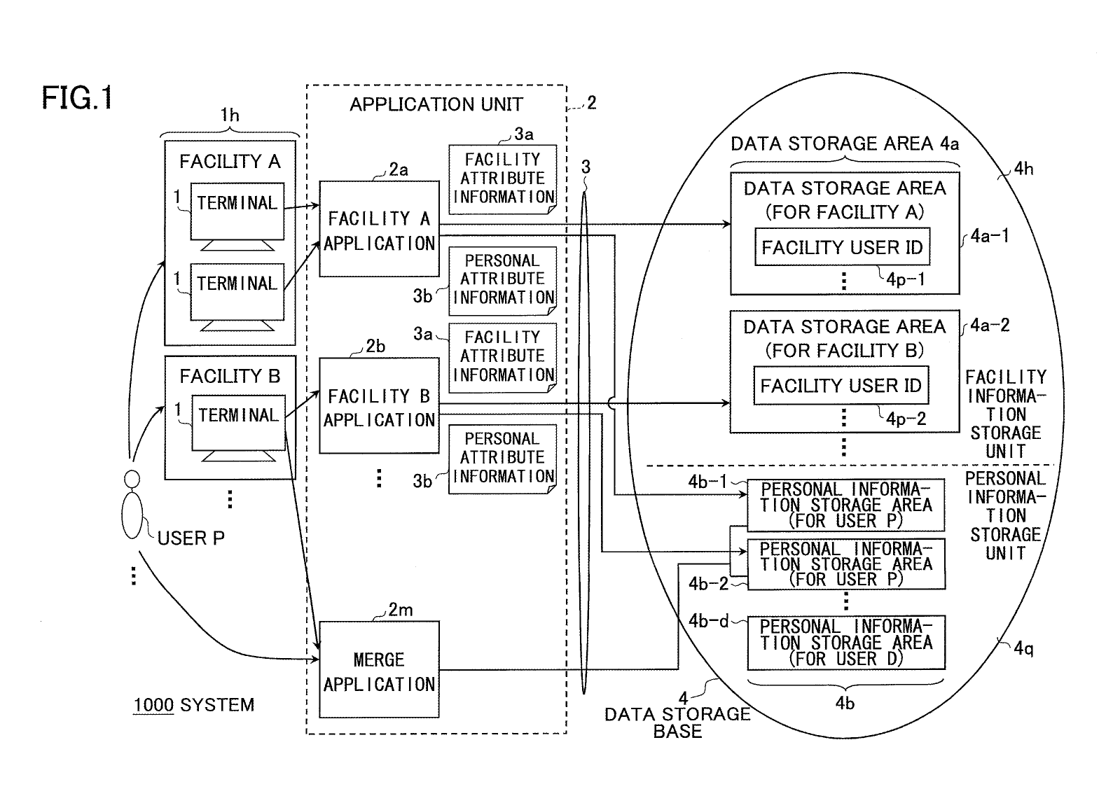

FIG. 1 is a diagram illustrating a conceptual configuration of a system 1000 according to the present embodiment. In FIG. 1, the system 1000 includes multiple terminals 1 of facilities A, B, etc. (collectively referred to as “facilities 1h” below), an application unit 2, and a data storage base 4. The application unit 2 accesses the data storage base 4 via the Internet 3.

A user P is a user who uses at least one of the facilities 1h. The respective facilities 1h include the terminals 1 for business use. Each of the terminals 1 is a computer device such as a PC (Personal Computer).

The application unit 2 includes a group of applications specifically provided for respective application users, which are represented by a facility-A application 2a specifically provided for the facility A and a facility-B application 2b specifically provided for the facility B, and a merge application 2m.

On a terminal 1 at the facility A, a CPU of the terminal 1 activates the facility-A application 2a, a person in charge at the facility A operates business relating to the user P using the facility-A application 2a. At the facility B, the specific facility-B application 2b is used in the same way. It is the same at the other facilities 1h.

The facility-A application 2a is an application specifically used at the facility A, and may be installed on each of terminals 1 at the facility A. Alternatively, the facility-A application 2a and the facility-B application 2b may be provided by a server apparatus at an ASP (Application Service Provider) via the Internet 3. Also, the server apparatus itself may exist in the data storage base 4.

The merge application 2m is an application to execute a merge process that merges personal attribute information 3b attributed to an individual user generated at the multiple facilities 1h, into a single storage area, which may be used at a terminal of the user P or the terminals 1 at multiple facilities 1h. When using the merge application 2m at one of the facilities 1h, a person in charge at the facility 1h merges the personal attribute information 3b attributed to the user P generated at the facility 1h, in response to a declaration made by the user P to merge the personal attribute information 3b in a single storage area.

The Internet 3 is a communication network that connects multiple computers in the present system with each other for communication, which may be connected wired or wireless.

The data storage base 4 includes one or more external storage devices that can be accessed by the multiple computers via the Internet 3. Each of the terminals 1 can access respective storage areas for the applications 2a, 2b, . . . , 2m, without recognizing a physical configuration of the data storage base 4. The data storage base 4 includes a facility information storage unit 4h and a personal information storage unit 4q.

The facility information storage unit 4h is a storage unit to manage data storage areas 4a specifically provided for the respective facilities 1h, and stores the facility attribute information 3a attributed to the respective facilities 1h. In the data storage areas 4a, a data storage area 4a-1 is a storage area specifically used by the facility-A application 2a, and stores the facility attribute information 3a for respective facility user IDs specifically managed at the facility A. A data storage area 4a-2 is a storage area specifically used by the facility-B application 2b, and stores the facility attribute information 3a for respective facility user IDs specifically managed at the facility B.

The personal information storage unit 4q is a storage unit to store personal attribute information 3b attributed to a user P, which has been generated when using the respective facilities 1h. In the personal information storage unit 4q, the personal attribute information 3b attributed to the user P is identified every time a registration is made for the user P by one of the respective facilities 1h.

Once the user P is registered at the facility A, a facility user ID 4p-1 is generated that is specifically managed by the facility-A application 2a, to be stored in the data storage area 4a-1 for the facility A. Also, a personal information storage area 4b-1 is allocated for the user P who has used the facility A. After the registration of the user P, it can be identified by specification information that specifies the personal information storage area 4b-1.

When the same user P is registered at the facility B, which is different from the facility A, a facility user ID 4p-2 is generated that is specifically managed by the facility-B application 2b, to be stored in the data storage area 4a-2 for the facility B. Also, a personal information storage area 4b-2 is allocated for the user P who has used the facility B. After the registration of the user P, it can be identified by specification information that specifies the personal information storage area 4b-2.

When a user D other than the user P is registered at one of the facilities 1h, a facility user ID is generated that is specifically managed by an application for the facility 1h, a personal information storage area 4b-d is allocated for the facility 1h, and it can be uniquely identified by specification information that specifies the personal information storage area 4b-d in the personal information storage unit 4q in the data storage base 4.

The specification information is information to specify a location in the personal information storage area 4b, and an URL (Uniform Resource Locator) or the like may be used. Each of the personal information storage areas 4b is uniquely identified by the specification information in the personal information storage unit 4q in the data storage base 4. Therefore, the specification information corresponds to a personal information ID that identifies personal information in the present system using the personal information storage unit 4q, which is provided for the multiple facilities 1h as a whole.

The personal information storage area 4b-1 allocated for the user P can be referred to by the facility A, but cannot be referred to by the facilities 1h other than the facility A. Similarly, the personal information storage area 4b-2 allocated for the user P can be referred to by the facility B, but cannot be referred to by the facilities 1h other than the facility B.

In the present embodiment, using the merge application 2m, the personal information storage area 4b-1 and the personal information storage area 4b-2 allocated for the same user P can be merged into one of them based on a declaration made by the user P.

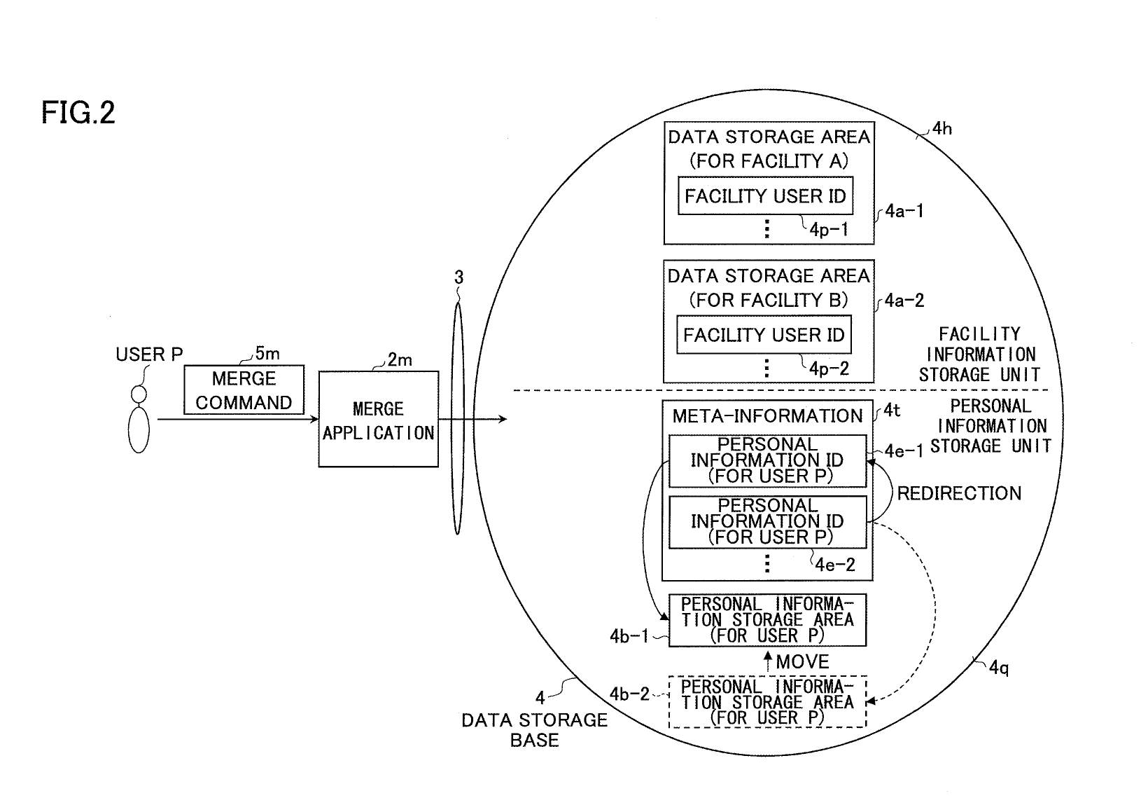

FIG. 2 is a diagram illustrating a merge process by the merge application 2m. FIG. 2 illustrates an example of data in the data storage base 4 when the user P uses the facility A and the facility B. In FIG. 2, in response to receiving a merge command 5m based on an initiative of the user P, the merge application 2m refers to meta-information 4t managed in the data storage base 4 via the Internet 3. The merge command 5m includes a specification of a merge destination that specifies the personal information ID 4e-1, and a specification that personal information ID 4e-2 is to be merged.

Based on the merge command 5m, the merge application 2m moves the personal attribute information 3b stored in the personal information storage area 4b-2 for the user P specified by the personal information ID 4e-2, to the personal information storage area 4b-1 for the user P specified by the personal information ID 4e-1 as the merge destination. Also, it rewrites the meta-information 4t so that the personal information ID 4e-2 is redirected to the personal information ID 4e-1. Thus, the personal information ID 4e-1 collectively stores the personal attribute information 3b for the user P that has been obtained at the facility A and the facility B.

The personal information ID 4e-2 is only redirected, and not deleted. Therefore, the facility-B application 2b can refer to the personal attribute information 3b about the user P, by using the personal information ID 4e-2, without any changes for the registered information. By merging in this way, if the user P reuses the facility B, the personal attribute information 3b can be referred to at the facility B that has been obtained at the facility A and the facility B using the personal information ID 4e-2.

The personal information ID 4e-1 is information that is indicated when the user P makes a registration at the facility A for the first use. It may be record on a medium such as a member's card, a patient registration card, or a point card at the facility A to be issued to the user P. The other personal information ID 4e-2 and the like may also be issued at the respective facility B and the like.

Although the above example is described assuming that the personal information ID 4e-1 and the personal information ID 4e-2 are issued at different facilities, namely, the facility A and facility B, the personal information IDs 4e-1 and 4e-2 may be doubly issued for the same user P at the same facility A. In a circumstance where the personal information ID 4e-1 cannot be confirmed that has been firstly issued for the user P at the facility A, data can be temporarily stored by newly issuing another personal information ID 4e-2 at the facility A. After that, with an agreement of the user P, the personal information ID 4e-2 may be merged into the personal information ID 4e-1.

If the facilities 1h including the facility A, the facility B, and the like are medical institutions such as hospitals, the user corresponds to a patient, and personal information IDs 4e-1 and 4e-2 correspond to the specification information specifying the personal information storage areas 4b-1 and 4b-2 to store PHRs (Personal Health Records). Also, the personal attribute information 3b corresponds to the PHRs.

When the personal information ID 4e-1 or 4e-2 is indicated to the user P at the registration, it may be recorded on a patient registration card issued at the individual facility A or facility B. Also, the user P may manage the personal information IDs 4e-1 and 4e-2 by himself, and may input it on a terminal 1 at a reception desk when receiving an examination for the next time.

In the following description, the facilities 1h are assumed to be different hospitals. For the facilities 1h being hospitals, the facility attribute information 3a and the personal attribute information 3b are distinguished based on the following notion.

For data about a patient, a part of the data can be considered as a property of a hospital that performs an examination, and another part of the data can be considered as a property of the patient. Findings about the patient are information that reflects a doctor' opinion, and may be valid to consider it as the property of the doctor or the hospital. On the other hand, it may be valid to consider that basic data indicating a health state of the patient such as the age, body weight, body height, normal blood pressure, blood type, medical history, and test results are a property of the patient.

Based on the above distinction, the data that is the property of the hospital corresponds to the facility attribute information 3a, and is stored in the facility information storage unit 4h to which the hospital has an administrative right. Also, the data that is the property of the patient corresponds to the personal attribute information 3b, and is stored in the facility information storage unit 4q to which the patient has an administrative right.

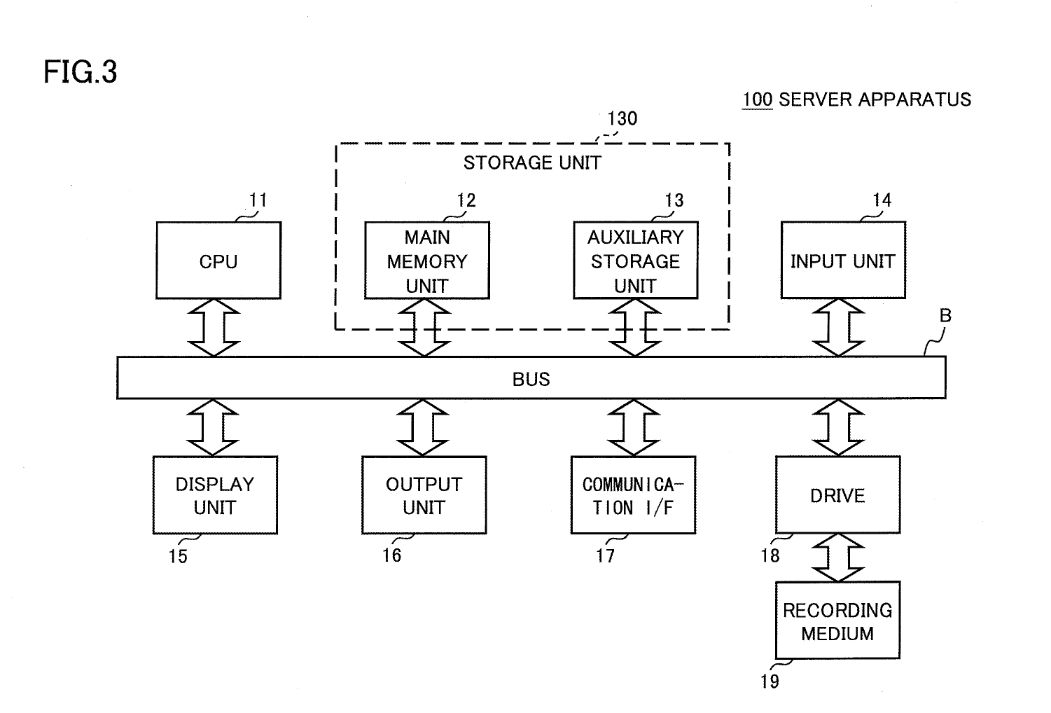

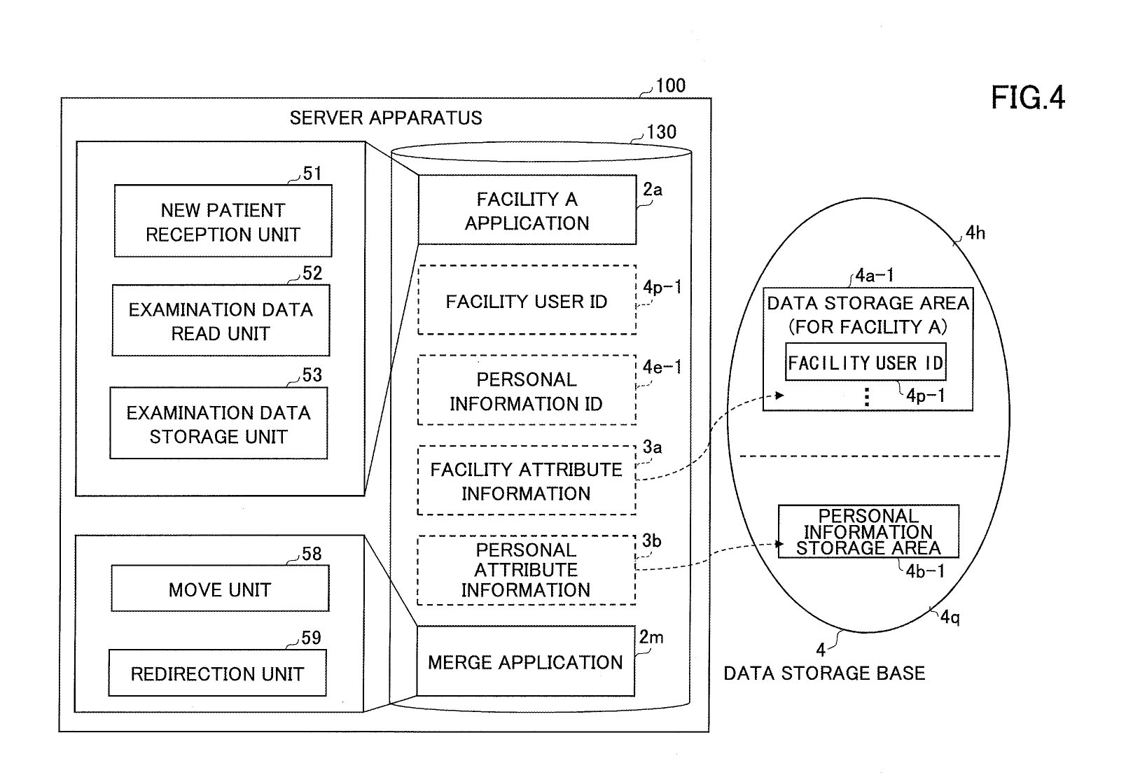

Assuming that that the facility A is a hospital, a hardware configuration and a functional configuration of a server apparatus 100 will be described that is connected with a terminal 1 in the facility A to provide the facility-A application 2a for the terminal 1, with reference to FIG. 3 and FIG. 4.

FIG. 3 is a diagram illustrating the hardware configuration of the server apparatus 100. The server apparatus 100 illustrated in FIG. 3 is an apparatus controlled by a computer, which includes a CPU (Central Processing Unit) 11, a main memory unit 12, an auxiliary storage unit 13, an input unit 14, a display unit 15, an output unit 16, a communication I/F (interface) 17, and a drive 18, which are connected with each other via a bus B.

The CPU 11 is a processor to control the server apparatus 100 following a program stored in the main memory unit 12. The main memory unit 12 uses a RAM (Random Access Memory) and a ROM (Read-Only Memory) to store the program executed by the CPU 11, data required for processing by the CPU 11, data obtained by the processing by the CPU 11, and the like. Also, a part of the area of the main memory unit 12 is allocated as a work area used for the processing by the CPU 11.

The auxiliary storage unit 13 uses a hard disk drive to store data for the program to execute various processes and the like. A part of the program stored in the auxiliary storage unit 13 is loaded in the main memory unit 12, which is executed by the CPU 11 to implement the various processes. The storage unit 130 includes the main memory unit 12 and/or the auxiliary storage unit 13.

The input unit 14 includes a mouse and a keyboard, which are used by a user to input various information required for a process by the server apparatus 100. The display unit 15 displays various required information under control of the CPU 11. The output unit 16 includes a printer used for outputting various information in response to a command made by a user. The communication I/F 17 is a device connected with, for example, the Internet or a LAN (Local Area Network) for controlling a communication with an external device.

The program to implement processes executed by the server apparatus 100 is provided for the server apparatus 100 by a recording medium 19, for example, a CD-ROM (Compact Disc Read-Only Memory). Namely, when the recording medium 19 storing the program is set into the drive 18, the drive 18 reads the program from the recording medium 19, and the read program is installed in the auxiliary storage unit 13 via the bus B. Then, when the program is activated, the CPU 11 starts processing following the program installed in the auxiliary storage unit 13. Note that the medium storing the program is not limited to a CD-ROM, but may be any computer-readable medium. Computer-readable media other than a CD-ROM include a DVD disk, a portable recording medium such as a USB memory, and a semiconductor memory such as a flash memory.

Also, the program to implement processes executed by the server apparatus 100 may be provided by the external device via the communication I/F 17. Alternatively, it may be configured so that the program is provided for the external device to implement processes described later by the external device. Communication by the communication I/F 17 is not limited to wireless or wired communication.

FIG. 4 is a diagram illustrating a functional configuration of the server apparatus 100. The server apparatus 100 illustrated in FIG. 4 includes a new patient reception unit 51, an examination data read unit 52, and an examination data storage unit 53, which are implemented by executing the facility-A application 2a. The server apparatus 100 includes a move unit 58 and a redirection unit 59, which are implemented by executing the merge application 2m. The server apparatus 100 may or may not have the merge application 2m installed. The merge application 2m may be installed on another server apparatus that can be accessed by a terminal 1.

The facility-A application 2a and the merge application 2m are stored in the storage unit 130 to be executed by the CPU 11.

The new patient reception unit 51 is a process unit to register a user P (patient) at an initial examination of the user P. Upon the registration of the user P, the new patient reception unit 51 generates a new facility user ID 4p-1 in the data storage area 4a-1 for the facility A in the data storage base 4, and outputs the generated facility user ID 4p-1. The output facility user ID 4p-1 is indicated to the user P. After the registration of the initial examination has been completed, the user P receives a doctor's examination. Data generated for the user P by the doctor's examination is separated into the facility attribute information 3a and the personal attribute information 3b, to be stored in the data storage base 4 by the examination data storage unit 53.

When the user P comes for a re-examination, the examination data read unit 52 reads out the facility attribute information 3a and the personal attribute information 3b from the data storage base 4, and temporarily stores them in the storage unit 130. Using the facility user ID 4p-1 (corresponding to a medical record number) of the user P, the examination data read unit 52 also reads out the facility attribute information 3a from the facility information storage unit 4h in the data storage base 4. Using the personal information ID 4e-1, the examination data read unit 52 also reads out the personal attribute information 3b from the personal information storage unit 4q in the data storage base 4.

When the personal information ID 4e-2 generated at the facility B (hospital) is redirected to the personal information ID 4e-1, the past personal attribute information 3b obtained at both the facility A and the facility B is read out even if it is an access to the personal information storage unit 4q using the personal information ID 4e-1.

The examination data storage unit 53 separates the data obtained with the examination of the user P into the facility attribute information 3a and the personal attribute information 3b, to store them in the data storage area 4a-1 for the facility A in the facility information storage unit 4h, and the personal information storage area 4b-1 in the personal information storage unit 4q, respectively, in the data storage base 4.

The move unit 58 is a process unit to merge two or more pieces of information in the personal information storage area 4b based on a merge command 5m by the user P. In the example in FIG. 1, if the merge command 5m specifies the personal information ID 4e-2 as a merge source, and specifies the personal information ID 4e-1 as a merge destination, the personal attribute information 3b stored in the personal information storage area 4b-2 specified by the personal information ID 4e-2 to be merged is moved in the personal information storage area 4b-1 specified by the personal information ID 4e-1 as the merge destination.

In the personal information storage area 4b-1, the personal attribute information 3b obtained at the facility A and the personal attribute information 3b obtained at the facility B exist. Therefore, after the merge, although the personal information ID 4e-2 continues to exist as the specification information, it may not be used because the personal information storage area 4b-2 stores the personal attribute information 3b generated by the facility B for the user P.

The redirection unit 59 is a process unit to add a description in the meta-information 4t for redirecting the personal information ID 4e-2 to be merged to the personal information ID 4e-1 as the merge destination, based on the merge command 5m by the user P.

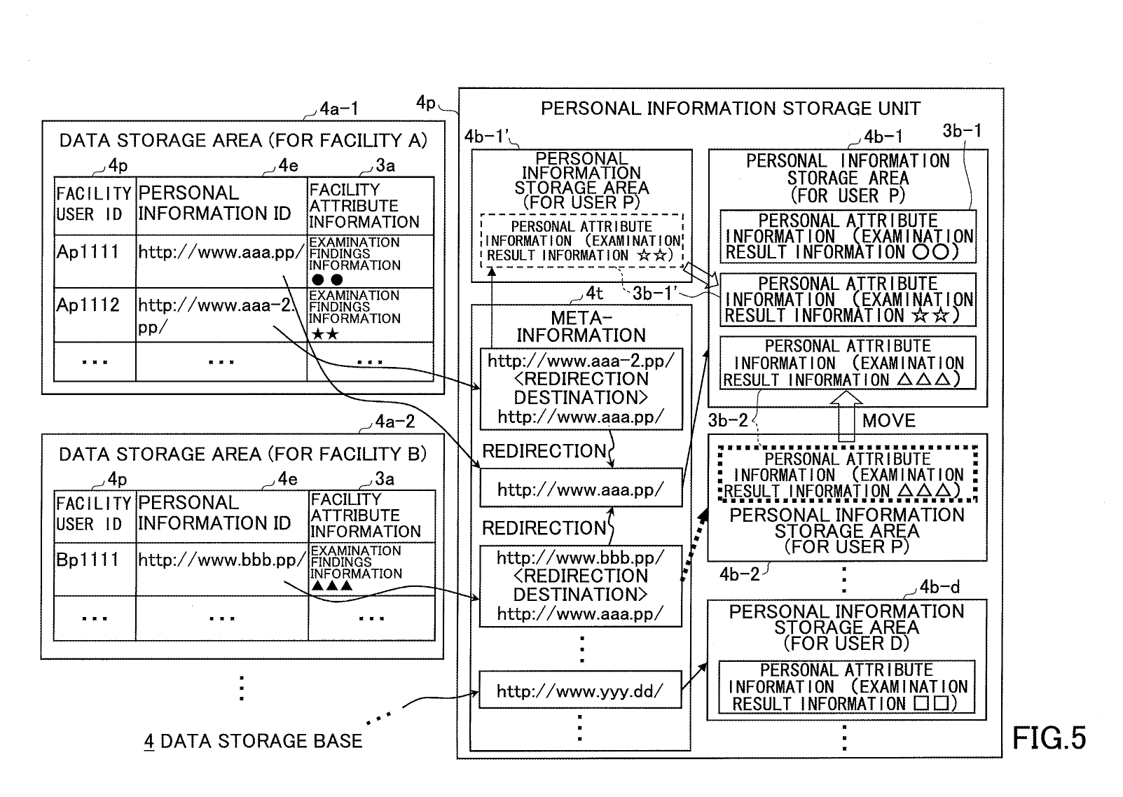

An example of a data configuration in the data storage base 4 will be described for a case where the facilities 1h are different hospitals, with reference to FIG. 5. FIG. 5 is a diagram illustrating an example of a data configuration in a data storage base. In FIG. 5, an URL is used as a personal information ID 4e.

In FIG. 5, the data storage area 4a-1 for the facility A stores a combination of a facility user ID 4p and a personal information ID 4e for each examination, added with the facility attribute information 3a. For example, the data storage area 4a-1 stores a combination of a facility user ID 4p “Ap1111” and a personal information ID 4e “http://www.aaa.pp/” added with the facility attribute information 3a of “examination findings information ”.

The facility-A application 2a can access the personal information storage area 4b-1 via the meta-information 4t by specifying “http://www.aaa.pp/”. Namely, the facility-A application 2a can access the personal attribute information 3b-1 including “examination result information ∘∘” stored in the personal information storage area 4b-1, and the personal attribute information 3b-2 including “examination result information ΔΔΔ” moved from the personal attribute information 3b-2 by redirection.

The data storage area 4a-2 for the facility B stores a combination of a facility user ID 4p and a personal information ID 4e for each examination, added with the facility attribute information 3a. For example, the data storage area 4a-2 for the facility B stores a combination of a facility user ID 4p “Bp1111” and a personal information ID 4e “http://www.bbb.pp/” added with the facility attribute information 3a of “examination findings information ▴▴▴”.

The facility-B application 2b can access the personal information storage area 4b-1 via the meta-information 4t by specifying “http://www.bbb.pp/”, which is redirected to “http://www.aaa.pp/”. Namely, the facility-A application 2b can access the personal attribute information 3b-1 including “examination result information ∘∘” stored in the personal information storage area 4b-1, and the personal attribute information 3b-2 including “examination result information ΔΔΔ” moved by redirection.

Originally, the personal information storage area 4b-1 is specifically provided for the facility A, which is an area that cannot be accessed from the facility B. However, if the personal information storage area 4b-2 is merged into the personal information storage area 4b-1 by a declaration of the user P stating that “http://www.aaa.pp/” and “http://www.bbb.pp/” are the personal information IDs 4e for the same person, the personal information storage area 4b-1 is accessible from both the facility A and the facility B with respect to the user P.

Specifically, basic data representing a health state obtained for the user P with a health examination at the facility B (hospital) is stored in the personal information storage area 4b-2. After the health examination, by an initiative of the user P, the personal attribute information 3b-2 including the basic data representing the health state in the personal information storage area 4b-2 is moved into the personal information storage area 4b-1.

After that, when the user P (patient) receives an examination at the facility A (hospital), the personal attribute information 3b-1 and the personal attribute information 3b-2 are displayed on a terminal 1 used by a doctor at the facility A (hospital). The doctor can refer to a result of the health examination performed at facility B (hospital), and hence, can give a diagnostic and treatment more efficiently and appropriately. Similarly, after the merge, the personal attribute information 3b-1 and the personal attribute information 3b-2 are also shared at facility B (hospital).

On the other hand, unless they are merged initiated by a declaration by the user P (patient), the personal attribute information 3b-1 and the personal attribute information 3b-2 are not shared that have been generated at the facility A (hospital) and the facility B (hospital), respectively.

Also, if the user P revisits the same facility A and an unusual situation arises such that the user P forgets to bring the personal information ID 4e; loses a medium including the personal information ID 4e such as a patient registration card; does not recognize the personal information ID 4e as the person in question; wants to get an examination at a different department at the facility A (hospital); or the like, then, a facility user ID “Ap1112” and a personal information ID of “http://www.aaa-2.pp/” are newly generated for the user P as a new patient in the data storage area 4a-1 managed by the facility A.

By “http://www.aaa-2.pp/”, a personal information storage area 4b-1′ is specified. Also, “examination findings information ★★” at this moment is stored in a data storage area 4a-1′, to store the personal attribute information 3b-1′ including “examination result information ⋆⋆”. After that, when a merge is made by a declaration of the user P stating that “http://www.aaa.pp/” and “http://www.aaa-2.pp/” are for the same user, one of them may be used to manage the personal attribute information 3b-1 and the personal attribute information 3b-1′.

Also, if the multiple facilities 1h including the facility A and the facility B are animal hospitals, there may be a case where a person other than an owner protects a stray dog wounded in a disaster such as an earthquake, brings the stray dog to an arbitrarily selected animal hospital to get treatment, and then, the stray dog is safely returned to the owner.

Although the owner uses the facility A (animal hospital) before the disaster, the stray dog cannot make a declaration about the use of the facility A (animal hospital) before the disaster. The person who protected the stray dog, at any rate, brings the stray dog to the facility B (animal hospital) to get treatment. Although the personal information storage area 4b-1 already exists for the stray dog in the personal information storage unit 4q in the data storage base 4 provided when the facility A (animal hospital) has been used before, the personal information storage area 4b-2 coexists that is provided when the facility B (animal hospital) is used.

On the other hand, the stray dog safely returned to the owner cannot explain the treatment at the facility B (animal hospital) to the owner. In such a circumstance, the owner may receive the personal information ID 4e from the person who gave the protection, and may issue a merge command 5m to the merge application 2m from the owner's terminal or a terminal 1 at the facility B (animal hospital), to manage the personal attribute information 3a about the stray dog in the personal information storage area 4b-1.

After that, when receiving an examination at the facility A (animal hospital), a veterinarian can refer to the personal attribute information 3a including that generated at the facility B (animal hospital) when protected. Therefore, the veterinarian can give a diagnosis and treatment efficiently and appropriately considering the health state of the stray dog soon after the disaster.

Although the personal information ID 4e is associated with the facility user ID 4p in the example of the data configuration in FIG. 5, the personal information ID 4e may be input by the user P at a terminal 1 when necessary so that it is not stored any places other than the personal information storage unit 4p.

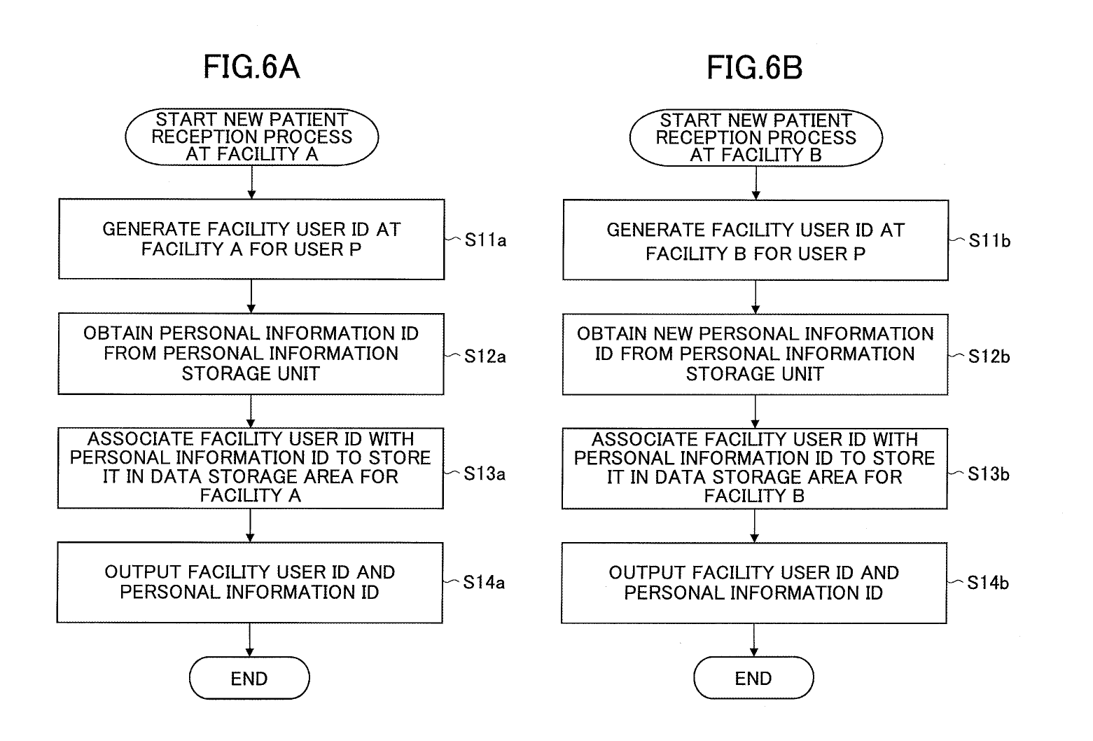

A new patient reception process executed by the new patient reception unit 51 will be described with reference to FIG. 6A and FIG. 6B. It will be described for a case where the user P receives examinations at the facility A and the facility B, which are hospitals different from each other. FIG. 6A is a flowchart illustrating a new patient reception process at the facility A. FIG. 6B is a flowchart illustrating a new patient reception process at the facility B.

In FIG. 6A, when the user P makes a registration at a reception desk at the facility A as a new patient, the new patient reception unit 51 of the facility-A application 2a starts executing a new patient reception process. The new patient reception unit 51 generates a facility user ID 4p “Ap1111” at the facility A (Step S11a).

The new patient reception unit 51 obtains a personal information ID 4e “http://www.aaa.pp” that identifies the specification information of the personal information storage area 4b-1 from the personal information storage unit 4q via the Internet (Step S12a). Then, the new patient reception process at the facility A associates the facility user ID 4p and the personal information ID 4e to store it in the data storage area 4a-1 for the facility A (Step S13a).

After that, the new patient reception unit outputs the facility user ID 4p and the personal information ID 4e on the display unit of the terminal 1 (Step S14a), and ends the new patient reception process at the facility A.

In FIG. 6B, when the user P makes a registration at a reception desk at the facility B, other than the facility A, as a new patient, the new patient reception unit 51 of the facility-B application 2b starts executing a new patient reception process. The new patient reception unit 51 generates a facility user ID at the facility B (Step S11b).

The new patient reception unit 51 obtains a personal information ID 4e “http://www.bbb.pp” that identifies the specification information of the personal information storage area 4b-2 from the personal information storage unit 4q via the Internet 3 (Step S12b). Then, the new patient reception process at the facility B associates the facility user ID and the personal information ID to store it in the data storage area 4a-2 for the facility B (Step S13b).

After that, the new patient reception unit outputs the facility user ID 4p and the personal information ID 4e on the display unit of the terminal 1 (Step S14b), and ends the new patient reception process at the facility B.

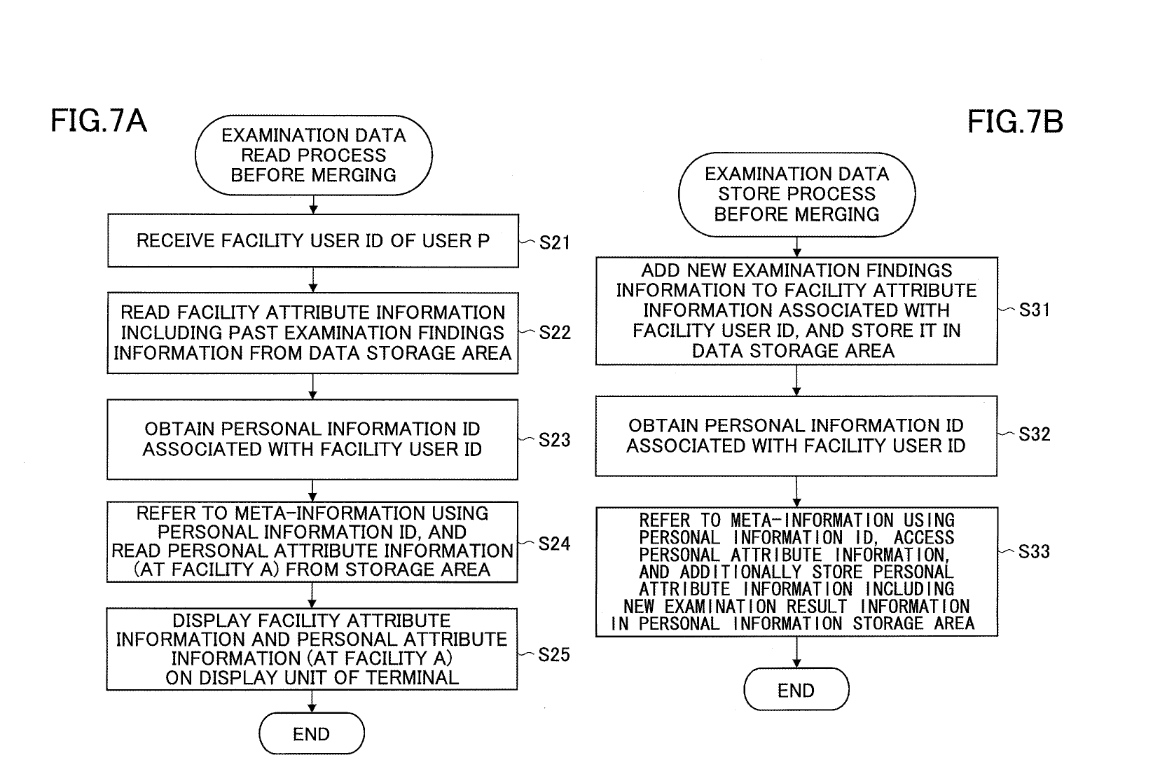

Next, an examination data read process by the examination data read unit 52 will be described when the user P receives an examination at the facility A before merging, with reference to FIG. 7A, and an examination data store process by the examination data storage unit 53 will be described that stores examination data obtained by the examination, with reference to FIG. 7B.

FIG. 7A is a flowchart illustrating an examination data read process before merging at the facility A. In FIG. 7A, the examination data read unit 52 of the facility-A application 2a receives the facility user ID 4p for the facility A from the user P as input (Step S21), and reads the facility attribute information 3a including examination findings information in the past from the data storage area 4a-1 for the facility A in the data storage base 4 (Step S22).

Also, the examination data read unit 52 obtains the personal information ID 4e “http://www.aaa.pp” associated with the facility user ID 4p “Ap1111” of the user P in the data storage area 4a-1 (Step S23). The examination data read unit 52 refers to the meta-information 4t using the personal information ID 4e, to read out the personal attribute information 3b-1 from the personal information storage area 4b-1 for the user P (Step S24). In this case, as it is before merging, only the personal attribute information 3b-1 is read out that has been obtained at the facility A.

Then, the examination data read unit 52 displays the facility attribute information 3a and the personal attribute information 3b-1 on the display unit on the terminal 1 at the facility A (Step S25), and ends the examination data read process. This examination read storage process is omitted for the first use.

FIG. 7B is a flowchart illustrating an examination data store process before merging at the facility A. In FIG. 7B, the examination data storage unit 53 of the facility-A application 2a additionally stores new examination findings information in the facility attribute information 3a associated with the facility user ID 4p of the user P in the data storage area 4a-1 for the facility A in the data storage base 4 (Step S31).

The examination data storage unit 53 obtains the personal information ID 4e associated with the facility user ID 4p (Step S32). Then, the examination data storage unit 53 accesses the personal information storage unit 4q with reference to the meta-information 4t using the personal information ID 4e, and additionally stores the personal attribute information 3b including new examination result information in the personal information storage area 4b-1 (Step S33).

The examination data read process illustrated in FIG. 7A and the examination data store process illustrated in FIG. 7B are similarly executed when the user P receives an examination at the facility B as long as it is before merging, and their description is omitted.

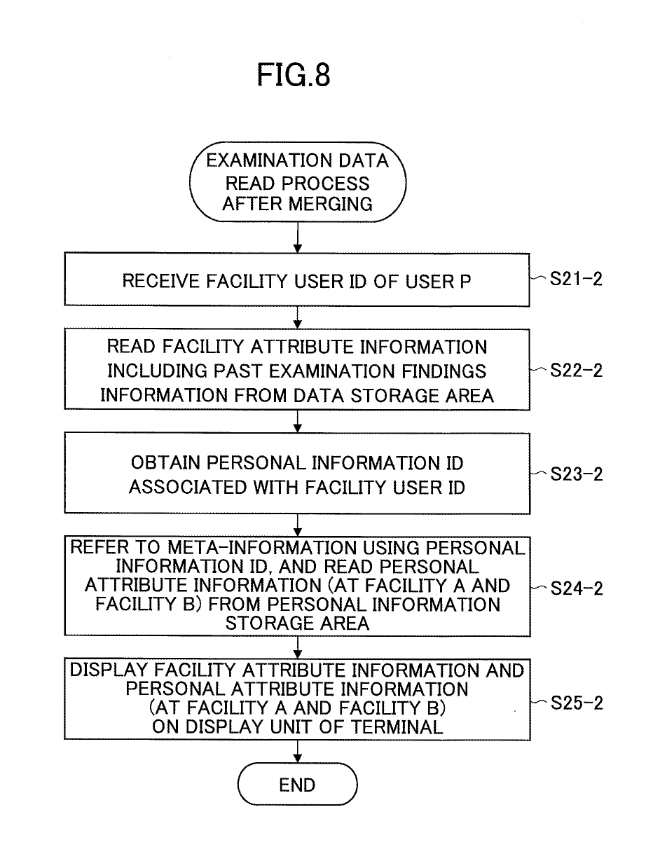

Next, an examination data read process by the examination data read unit 52 will be described with reference to FIG. 8 when the user P receives an examination at the facility A after the personal attribute information 3b-2 obtained at the facility B for the user P has been merged into the personal information storage area 4b-1 in the personal attribute information 3b-1 obtained at the facility A.

FIG. 8 is a flowchart illustrating an examination data read process after the merge at the facility A. In FIG. 8, the examination data read unit 52 receives the facility user ID 4p for the facility A from the user P (Step S21-2), and reads the facility attribute information 3a including examination findings information in the past from the data storage area 4a-1 for the facility A in the data storage base 4 (Step S22-2).

Also, the examination data read unit 52 obtains the personal information ID 4e “http://www.aaa.pp” associated with the facility user ID 4p “Ap1111” of the user P in the data storage area 4a-1 (Step S23-2). The examination data read unit 52 refers to the meta-information 4t using the personal information ID 4e, and reads out the personal attribute information 3b-1 and the personal attribute information 3b-2 from the personal information storage area 4b-1 for the user P (Step S24-2). In this case, as it is after merging, the personal attribute information 3b-1 obtained at the facility A and the personal attribute information 3b-2 obtained at facility B are read out.

Then, the examination data read unit 52 displays the facility attribute information 3a, the personal attribute information 3b-1, and the personal attribute information 3b-2 on the display unit on the terminal 1 at the facility A (Step S25-2), and ends the examination data store process.

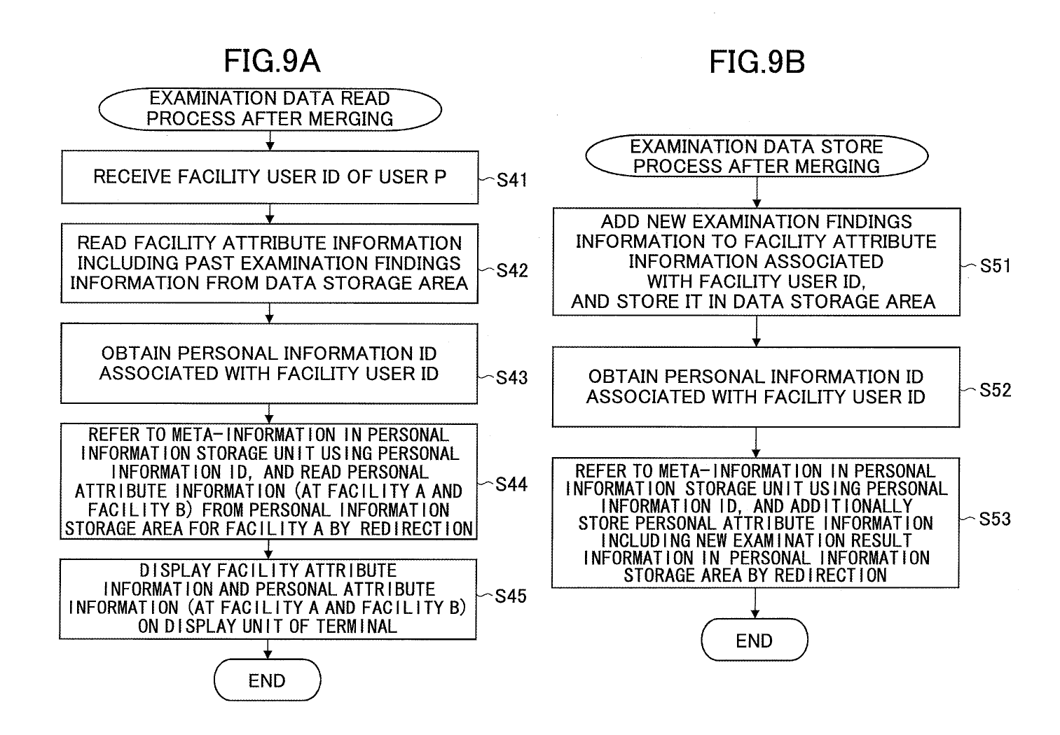

Next, an examination data read process and examination data store process will be described with reference to FIG. 9A and FIG. 9B when the user P receives an examination at the facility B after the personal attribute information 3b-2 obtained at the facility B for the user P has been merged into the personal information storage area 4b-1 in the personal attribute information 3b-1 obtained at the facility A.

FIG. 9A is a flowchart illustrating an examination data read process after merging at the facility B. In FIG. 9A, the examination data read unit 52 of the facility-A application 2b receives the facility user ID 4p for the facility B from the user P as input (Step S41), and reads the facility attribute information 3a including examination findings information in the past from the data storage area 4a-2 for the facility B in the data storage base 4 (Step S42).

Also, the examination data read unit 52 obtains the personal information ID 4e “http://www.bbb.pp” associated with the facility user ID 4p “Bp1111” of the user P in the data storage area 4a-2 (Step S43). The examination data read unit 52 refers to the meta-information 4t using the personal information ID 4e, and by redirection to “http://www.aaa.pp”, reads out the personal attribute information 3b-1 including the examination result information obtained at the facility A, and the personal attribute information 3b-2 including the examination result information obtained at the facility B, from the personal information storage area 4b-1 for the user P (Step S44).

Then, the examination data read unit 52 displays the facility attribute information 3a and the personal attribute information 3b-2 on the display unit on the terminal 1 at the facility A (Step S45), and ends the examination data read process.

FIG. 9B is a flowchart illustrating an examination data store process after merging at the facility B. In FIG. 9B, the examination data storage unit 53 of the facility-B application 2b additionally stores new examination findings information in the facility attribute information 3a associated with the facility user ID 4p of the user P in the data storage area 4a-2 for the facility B in the data storage base (Step S51).

The examination data storage unit 53 obtains the personal information ID 4e associated with the facility user ID 4p (Step S52). Then, the examination data storage unit 53 refers to the meta-information 4t using the personal information ID 4e, and by redirection to “http://www.aaa.pp”, additionally stores the personal attribute information 3b including new examination result information in the personal information storage area 4b-1 for the facility A (Step S53).

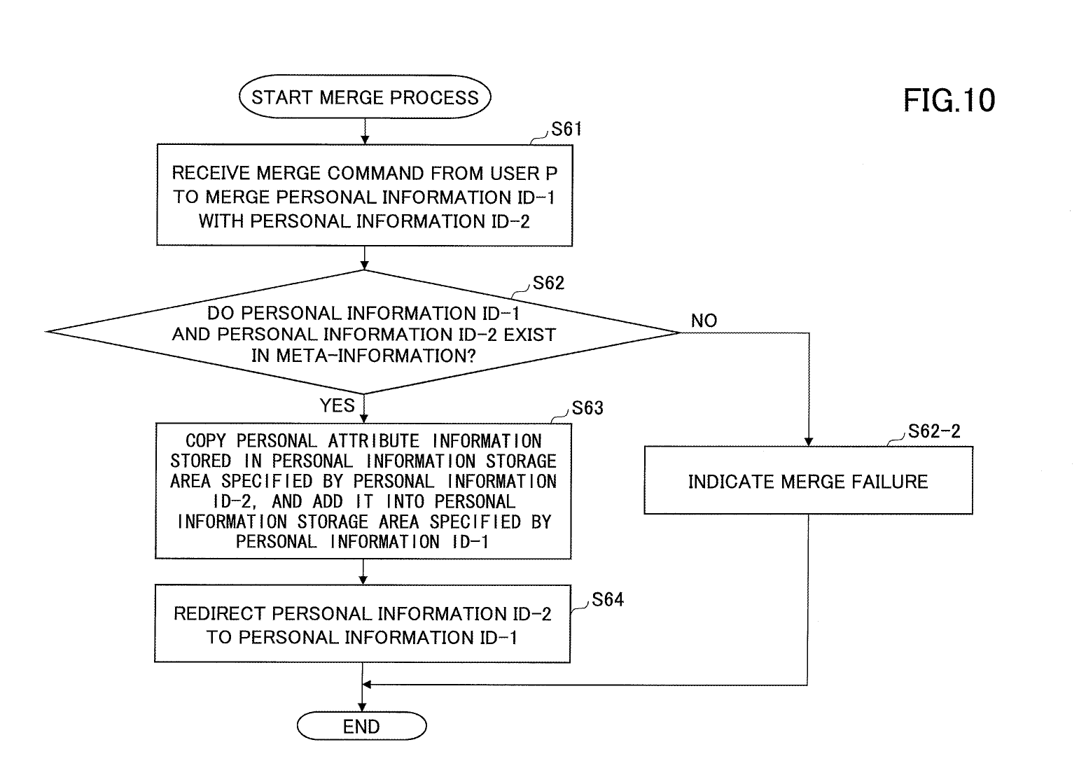

Next, a merge process by the merge application 2m will be described with reference to FIG. 10. FIG. 10 is a flowchart illustrating a merge process. In FIG. 10, a personal information ID-1 corresponds to “http://www.aaa.pp/” obtained for the user P at the facility A, and a personal information ID-2 corresponds to “http://www.bbb.pp/” obtained for the user P at the facility B.

In response to receiving a merge command 5m from the user P to merge the personal information ID-1 with the personal information ID-2 (Step S61), the move unit 58 confirms whether the personal information ID-1 and the personal information ID-2 specified in the merge command 5m exist in the meta-information 4t (Step S62). If both or one of the personal information ID-1 and the personal information ID-2 do not exist in the meta-information 4t, the move unit 58 indicates a merge failure to the user P (Step S62-2), and ends the merge process.

On the other hand, if the personal information ID-1 and the personal information ID-2 exist in the meta-information 4t at Step S62, the move unit 58 copies the personal attribute information 3b stored in the personal information storage area 4b-2 specified by the personal information ID-2, and adds it into the personal information storage area 4b-1 specified by the personal information ID-1 (Step S63). The redirection unit 59 adds a description for the personal information ID-2 in the meta-information 4t to redirect the personal information ID-2 to personal information ID-1 (Step S64), and ends the merge process.

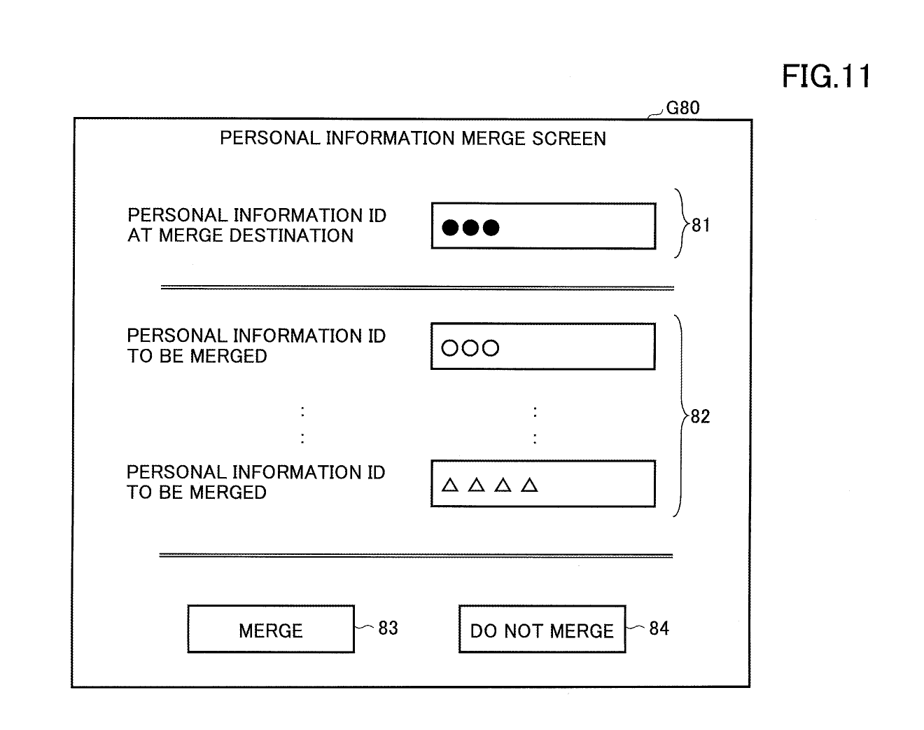

FIG. 11 is a diagram illustrating an example of a screen for setting merge information. An example of a personal information merge screen G80 illustrated in FIG. 11 includes an input area 81 to input a personal information ID as a merge destination, an input area 82 to input another personal information ID to be merged, a button 83 to execute a merge process, and a button 84 to cancel the input not to execute the merge process.

The input area 81 is an area for inputting a personal information ID 4e as a merge destination. In the example of the data configuration illustrated in FIG. 5, “http://www.aaa.pp/” is input into the input area 81. The input area 82 is an area for inputting at least one personal information ID 4e to be merged other than the personal information ID 4e input into the input area 81. In the example of the data configuration illustrated in FIG. 5, “http://www.bbb.pp/” is input into the input area 81.

After inputting into the input area 81 and the input area 82, if the button 83 is selected, a merge process is executed. On the other hand, if the button 84 is selected, information input into the input area 81 and the input area 82 becomes invalid, and the merge process is not executed.

As described above, the multiple facilities 1h in the present embodiment can be used for multiple hospitals. Personal attribute information 3b obtained as PHRs and the like at two or more hospitals and stored at the multiple hospitals can be treated information attributed to the same user P (patient) by a declaration of the user P (patient) stating that they are for the same user P.

Also, the facilities 1h may be corresponded with different departments within a hospital. After personal attribute information 3b has been generated for each of the departments, by a declaration of the user P, multiple pieces of personal attribute information 3b can be merged into a single personal information storage area 4b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage area management method executed by a computer, the method comprising:
generating a first facility user ID for a user intending to use a first facility in a first data storage area under management of the first facility, the first facility user ID being capable of identifying the user under the management of the first facility;
identifying a first personal information ID to specify a first personal information storage area storing personal attribute information attributed to the user, by an input from the user on use of the first facility, or identifying a second personal information ID newly specifying a second personal information storage area from a personal information storage unit; and
storing data generated by the use of the first facility by the user, in the first data storage area and in a storage area identifiable among one of the first personal information storage area and the second personal information storage area.

2. The storage area management method as claimed in claim 1, wherein the storing stores facility attribute information attributed to the facility, among pieces of the data generated by the use of the first facility by the user, in the first data storage area,
wherein the storing stores personal attribute information attributed to the user, in the storage area identifiable among one of the first personal information storage area and the second personal information storage area.

3. The storage area management method as claimed in claim 2, wherein the identifying receives the first facility user ID from the user as input on the use of the first facility,
reads the facility attribute information previously associated with the first facility user ID from the first data storage area of the first facility, and
reads out the personal attribute information from the first personal information storage area or the second personal information storage area, using the first personal information ID or the second personal information ID associated with the first facility user ID from the first data storage area.

4. The storage area management method as claimed in claim 3, wherein the generating identifies the first personal information ID from the personal information storage unit when generating the first facility user ID,
associates the first facility user ID with the first personal information ID to store in the first data storage area, and
outputs the first personal information ID.

5. The storage area management method as claimed in claim 4, wherein the generating generates a second facility user ID for the user intending to use a second facility in a second data storage area under management of the second facility, the second facility user ID being capable of identifying the user under the management of the second facility;
wherein the identifying identifies a third personal information ID from the personal information storage unit,
wherein the storing stores personal attribute information attributed to the user, among pieces of data generated by the use of the second facility, in a third personal information storage area specified by the third personal information ID,
associates the second facility user ID with the third personal information ID, to store in the second data storage area, and
makes the personal attribute information readable, which has been generated by the use of the first facility and the second facility, using the first or second personal information ID at the first facility, or using the third personal information ID at the second facility, in response to a declaration by the user stating that the first or second personal information ID, and the third personal information ID are for the same user.

6. The storage area management method as claimed in claim 5, wherein in response to a merge command to merge the personal attribute information in one of the first personal information storage area, the second personal information storage area, and the third personal information storage area, the merge command being issued based on a declaration by the user, the storing moves the personal attribute information to a merge destination specified in the merge command, and
in accordance with the merge command, redirects a merge source to the merge destination for the first personal information ID, the second personal information ID, and the third personal information ID.

7. A server apparatus comprising:
a processor; and
a memory,
wherein the processor is configured to generate a first facility user ID for a user intending to use a first facility in a first data storage area under management of the first facility, the first facility user ID being capable of identifying the user under the management of the first facility,
to identify a first personal information ID to specify a first personal information storage area storing personal attribute information attributed to the user, by an input from the user when using the first facility, or identifying a second personal information ID newly specifying a second personal information storage area from a personal information storage unit, and
to store data generated by use of the first facility by the user, in the first data storage area and in a storage area identifiable among one of the first personal information storage area and the second personal information storage area.

8. A non-transitory computer-readable recording medium having a program stored therein for causing a computer to execute a storage area management process, the storage area management process comprising:
generating a first facility user ID for a user intending to use a first facility in a first data storage area under management of the first facility, the first facility user ID being capable of identifying the user under the management of the first facility;
identifying a first personal information ID to specify a first personal information storage area storing personal attribute information attributed to the user, by an input from the user when using the first facility, or identifying a second personal information ID newly specifying a second personal information storage area from a personal information storage unit; and
storing data generated by use of the first facility by the user, in the first data storage area and in a storage area identifiable among one of the first personal information storage area and the second personal information storage area.
